(19) United States
(12) Patent Application Publication
(10) Pub. No.: US 2015/0100598 A1
(43) Pub. Date: Apr. 9, 2015

(54) ASSISTED NAME CHANGE AUTOMATION SYSTEM

(71) Applicant: Blue Bird, LLC, Potomac, MD (US)

(72) Inventors: Michael Bradicich, Reston, VA (US); Culin Tate, Potomac, MD (US); Danielle Tate, Potomac, MD (US)

(21) Appl. No.: 14/302,588

(22) Filed: Jun. 12, 2014

Related U.S. Application Data
(60) Provisional application No. 61/888,058, filed on Oct. 8, 2013.

(51) Int. Cl. G06F 17/30

(52) U.S. Cl. CPC G06F 17/3064
USPC 707/767

(57) ABSTRACT

An assisted name change automation (ANCA) system provides analytically derived name change recommendations to women considering marital name changes. The ANCA system provides the user with a questionnaire asking a number of questions relevant to the name change decision. The results are then used to score the available choices based on a statistical analysis of a large number of prior name change decisions. A number of demographic factors may be taken into consideration, such as the subject's geographical location, age, education level, profession, whether the subject has brothers with the same last name, and so forth. The name change recommendation is then displayed to the user. A detailed report may also be presented to the user including the recommended name change, if any, along with a graphical presentation of how the user's questionnaire responses compare with the data in the historical database.

### REFERENCE TO RELATED APPLICATION

This application claims priority to U.S. Provisional Patent Application Ser. No. 61/888,058 entitled “Assisted Name Change Automation System” filed Sep. 26, 2013, which is incorporated by reference.

### TECHNICAL FIELD

The present invention relates to automated document preparation and submission systems and, more particularly, to an assisted name change automation credentialing system that provides an analytically derived name change recommendation to persons considering marital name changes.

### BACKGROUND

Women in the United States typically have five options for marital name changes: keeping their maiden name, adopting a hyphenated last name, adopting two last names, changing their last name to their spouse's last name while changing their middle name to their maiden name, and changing their last name to their spouse's surname. Many factors should be taken into account when considering the options for the marital name change. Family, professional, children, and other life factors may be affected by the decision. While there are conventional systems for automating the credentialing process once the name change has been selected, there is presently no system available to assist the newlywed in making the decision of which name change, if any, to select. There is, therefore, a continuing need for an improved name change automation system that provides assistance in making the name change decision.

### SUMMARY

The present invention may be embodied in an assisted name change automation (ANCA) system that provides analytically derived name change recommendations to women considering marital name changes. The ANCA system provides the user with a questionnaire asking a number of questions relevant to the name change decision. The results are then used to score the available choices based on a statistical analysis of a large number of prior name change decisions. The ANCA system may take a number of demographic factors into consideration that statistically correlate with the name change decision, such as the subject's geographical location, age, education level, profession, whether the subject has brothers with the same last name, and so forth. The name change recommendation is then displayed to the user. A detailed report may also be presented to the user including the recommended name change, if any, along with a graphical presentation of how the user's questionnaire responses compare with the data in the historical database.

Based on the recommendation and other information in the name change report, the user may communicate name change instructions along with feedback to the ANCA system. Each user's name change decision and demographic factors may also be fed back as an input to the name change database to continually update the database based on experience using the ANCA system. The name change database itself does not have to be maintained in each instance of the ANCA, where the name change analysis engine may utilize a name change questionnaire with statistical correlations based on an analysis of the name change information in the name change database. In addition, a centralized name change database may receive updates from a number of local ANCA systems, where the name change analysis engine utilizes a name change questionnaire in which the statistical correlations are continually updated based on the centrally maintained name change database.

Optionally, once the name change decision has been made, the ANCA system may prepare and submit the name change documentation for the user. The system may also obtain the necessary signatures, assemble the user's preexisting credentials, and submit the completed name change documentation along with the preexisting credentials to the appropriate credentialing authorities. The new credentials, such as a driver's license, social security card, and passport, are then provided to the user by the credentialing authorities. Feedback from the users is utilized to continually update the database and improved the questionnaire and scoring algorithm.

Additional features and advantages may be realized through the techniques of the present invention. Other embodiments and aspects of the invention are described below and considered a part of the claimed invention. For a better understanding of the invention with the advantages and the features, refer to the description and to the drawings.

### BRIEF DESCRIPTION OF THE FIGURES

FIG. 1 is a functional block diagram of an assisted name change automation system.

FIG. 2 is an example scoring table for the ANCA system.

FIG. 3 is an example scoring table for the ANCA system.

FIG. 4 is an example computer network diagram for the ANCA system.

FIG. 5 is a logic flow diagram for an assisted name change procedure.

FIG. 6 is a user interface panel for initiating a request for a computer-generated name change recommendation in an assisted name change system.

FIG. 7 is a user interface panel for entering a user's age in the assisted name change system.

FIG. 8 is a user interface panel for entering information regarding the user's use of business cards in the assisted name change system.

FIG. 9 is a user interface panel for entering information regarding the user's preference for having children in the assisted name change system.

FIG. 10 is a user interface panel for entering information regarding the user's wedding planning in the assisted name change system.

FIG. 11 is a user interface panel for entering information regarding the user's planned honeymoon in the assisted name change system.

FIG. 12 is a user interface panel for entering information regarding the user's wedding dress in the assisted name change system.

FIG. 13 is a user interface panel for entering information regarding whether the user has brothers in the assisted name change system.

FIG. 14 is a user interface panel for entering information regarding the user's level of education in the assisted name change system.

FIG. 15 is a user interface panel for entering information regarding the user's name and address information in the assisted name change system.

FIG. 16 is a user interface panel displayed while the assisted name change system computes a name change recommendation for the user.

FIG. 17 is a user interface panel displaying the computed name change recommendation to the user.

### DETAILED DESCRIPTION

The assisted name change automation (ANCA) system suggests possible new names based on the user's answers to a series of questions related to an algorithm based on data gathered, which at the time of this application includes over 150 thousand previous name change decisions and related demographic information. The scope of the database is expected to significantly increase over time with future use of the system and data mining activities. Although the description and figures generally refer to a female as the subject of the prospective name change, the ANCA system may also be used for persons engaging in same sex marriages and adoptions.

In a particular embodiment described below as one possible example of the ANCA system, the final name change recommendation is based on these criteria/categories included in the questionnaire presented to the user:

a) Length of current last name and spouse's last name

b) Use of current name in profession

c) Whether the user has male siblings (brothers)

d) Age

e) Address/Geographic Location

f) Spouse involvement in marriage issues

g) Available options depending on local laws

h) Likelihood to break from conventional norms

i) Number of children or expected children

The questionnaire presented by the system asks a series of multiple choice or short answer questions to solicit the relevant information from the users. Once the information has been gathered from the user, the system determines what name change options are available to the user—Some states do not allow for all options, any unavailable options are suppressed for these users. The system also generates a suggested new name for the user, displays a graph indicating where the users answers put them in a array of possible name change options and provides information on the most likely name change option for the user, and other options they may be interested in. The results, which include at least a suggested name change and may include other items, are calculated based on a assigning a weighted value to each answer, and a weighted value to each questions. The answer weight is multiplied by the question weight, all the results are totaled across all questions, then the results is divided by the total possible points to compute a relative percentage score. That score is translated into a graph for the user (the user may never see the actual score).

The graph of name change options typically display a linear progression of name change options from traditional to non-traditional and indicate where the user falls in that progression.

a) Take husband's name

b) Take maiden name as middle name and take husbands last name

c) Use two last names

d) Hyphenate last names

e) Keep current last name

Users will be able to share the results with others via email and/or social media. Users will also be able to return the results later, based on a unique link emailed to user after completion. Further detail on how questions were selected, and how the responses are valued and weighted are as follows.

Questions were selected by analyzing historical data to determine which factors produced a statistical spread in name change options ranging from: “No Change” to “Take Spouse's Name.” Additional customer interviews may be conducted to determine what additional factors influence their selection of a new last name. This analysis along with any interview results are used to produce the criteria/categories for inquiry, which are in the form of a set of unique questions that solicit the desired information in a non-obvious and user friendly manner. The questions are preferably designed to fun and interesting while avoiding potentially offensive subject matter.

In the particular example used to explain the principles of the invention, each possible answer is assigned a value on a scale from 0-6 points with the highest point value assigned to the option “take spouses name.” A continuum is established in the order: Take spouse's name, maiden to middle, two last names, hyphenate, no change. For each Question type—Example Age—the system analyzed data for over 150 martial name changes. The age range with the highest probably for taking spouses name is assigned the highest vale (in this example 6 points). The age ranges are typically broken into 3-4 logical categories, in this example under 24, 25-30, 31-35, 35 plus. These categories were chosen due to statistical infection points identified in the historical data for the name change options selected. Next each category or answer is assigned a value on the 6 point scale relative to that categories deviation from the highest value category—Take spouse name. This process of data analysis is followed for each of the questions types in our data set.

Each question is assigned a weight on a scale 0 to 1.0 with 1.0 being the most influential. Initial question weights have been set by surveying and interviewing marital status name changers as to what factors most influenced their choice in the available name change options.

A score is produce by summing each answer value and dividing by the sum of the question weights. This sum is then used to select a point on the continuum of name change options as detailed above. The result is displayed graphically to the user with a primary and secondary name change suggestion. The results report also includes a narrative which describes the suggested option and how that relates to the answers you provided.

One or more feedback loops may also be employed to refine and improve the system. System users may be surveyed to assess how the results fit their name change views. Users may be tracked through the name change process to compare suggested results to actual name change executed. Overall name change data quiz system user and non-quiz user data may also be used to further inform the process.

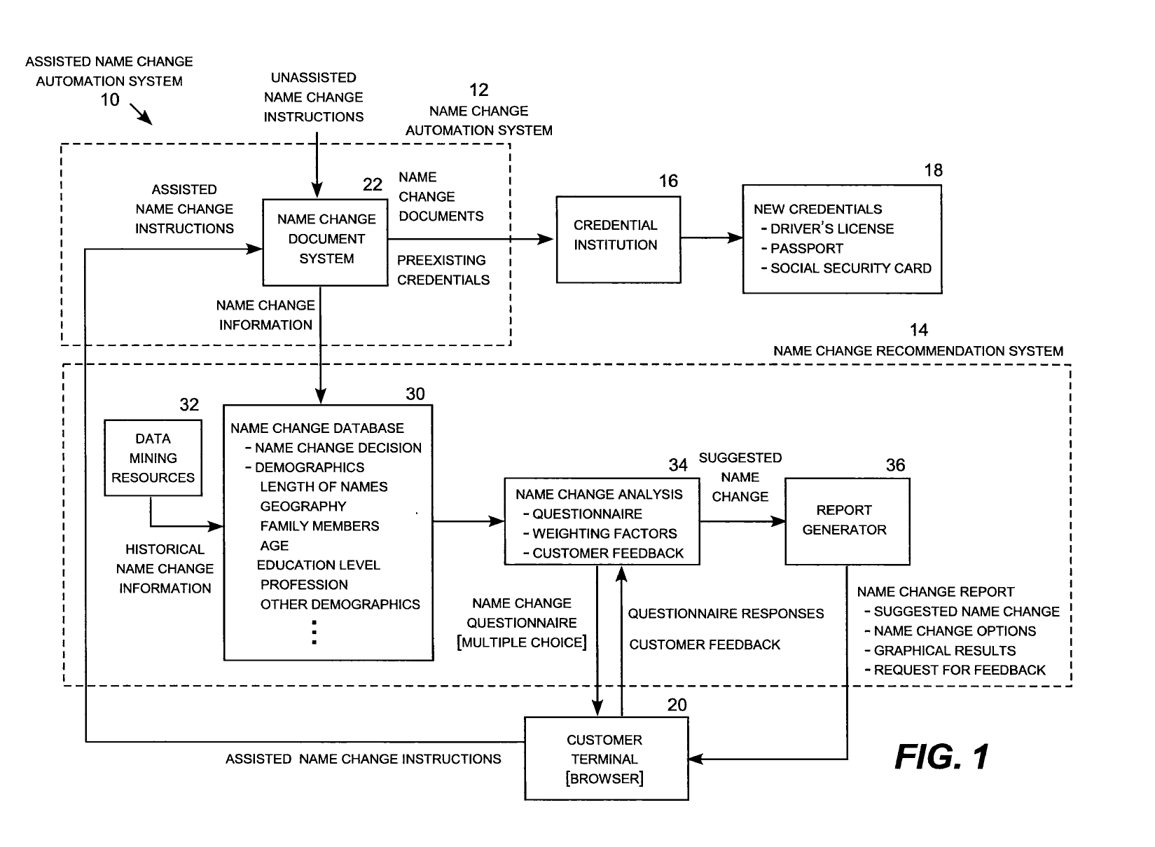

Referring now to the figures, the Assisted Name Change Automation (ANCA) system may be embodied as a computer algorithm running on any suitable computer platform. A typical deployment includes a server running an ANCA application that is accessed by users over a suitable network, such as the Internet. FIG. 1 is a functional block diagram and an example ANCA system 10, which typically includes a name change automation system 12 that interacts with a name change recommendation system 14. The name change automation system 12 may be a conventional approach to credentialing, while the name change recommendation system 14 represents a novel improvement to that system which provides the user with a recommendation and other information to assist in making the name change decision. Typically, the name change automation system 12 can be operated with or without the name change recommendation system 14 and they may be implemented on the same host computer as cooperating components of an integrated ANCA system. Users access the name change recommendation system 14 via a customer terminal 20, which may be any type of suitable computer system. A browser interface may be used for interaction between the customer terminal 20 and the ANCA system 10.

The name change automation system 12 includes a name change document system 22 receives name change instructions from users, whether they are assisted or unassisted name change instructions. The name change automation system 12 then prepares the appropriate name change documents for signature by the user. The signed name change documents are then sent, typically along with the user's existing credentials, to the appropriate credentialing authorities 18. The authorities then issue the new credentials, such as a new driver's license, social security card, and passport in the selected name of the user. The name change document system 22 and submits the name change information for each user (along with any demographic information available for users submitting unassisted name change instructions who did not enter through the name change recommendation system 14) to a name change database 30 in the name change recommendation system 14, where it becomes part of the historical information maintained by the database. This continually updates the information in the database with new information as it becomes available through the name change automation system 12.

The name change recommendation system 14 includes the name change database 30, which includes name change decisions along with demographic information (and questionnaire results for those users of the name change recommendation system 14) for a large number of subjects making name changes. The information maintained in the database for each subject may include, where available, the name change decision, length of the subject's maiden and the spouse's last names, the geographic location of the subject, family members of the subject (e.g., whether the subject has brothers with the maiden name), age, educational level, profession, any additional information obtained through the questionnaire, and other information that may be deemed relevant based on experience with the system and other considerations.

In addition the name change information entering the database 30 through the name change automation system 12, the database may be augmented with additional name change information obtained from data mining resources 32, typically public records pertaining to name changes, survey results or other data sources.

Statistical analysis of the information in the database 30 is performed to create a questionnaire that is used to obtain relevant information from users of the name change recommendation system 14. For a particular user, the name change analysis engine 34 submits the questionnaire (typically in multiple choice format) to the user's terminal 20 along with a request for user feedback and obtains the questionnaire responses and user feedback from the user. The name change analysis engine 34 then scores the name change options based on the questionnaire responses and weighting factors computed through statistical analysis of the information in the database 30. The weighting factors typically apply a determined weight in the range from 1-6 to each question (question weight) in the questionnaire and weight the user's response (response weight) based on the historical correlation of the response to the name change decisions reflected in the database (typically a percentage). The question weights and response weights are then combined (typically multiplied) and normalized (typically divided by the sum of the question weights) for each name change choice to obtain a score for each choice.

The name change recommendation system 14 also includes a report generator 36 that puts the name change recommendation into a report format along with additional information, such as the scoring derived for each name change choice, a textual personality description and graphical presentation of how the user's questionnaire responses compare to historical averages. Statistical results may be presented for various demographic categories, such as age (e.g., showing the percentage of the name change decisions for persons in the same geographic category as the user), age (e.g., showing the percentage of the name change decisions for persons in the same geographic category as the user), and so forth.

The ANCA system utilizes at least two types of feedback shown in FIG. 1. The first type of feedback includes each user's name change decision and associated demographic information, which is received by the name change automation system 12 for execution in new credentialing. The questionnaire may also ask the user for specific feedback, such as the user's perception of the accuracy of the personality description, how persuasive she found the name change recommendation, other factors that the user considered in making the decision, and the factors (including those in the questionnaire as well as those not included in the questionnaire considered by the user) that the user considered most relevant when making the name change decision. The user's responses to the feedback questions are received by the name change analysis engine 34, which ultimately takes this feedback information into account when updating the questionnaire, developing the weighting factors, developing the scoring algorithm, and developing new feedback questions.

The name change database 30 does not have to be maintained in each instance of the ANCA, where the name change analysis engine 34 may utilize on the name change questionnaire with statistical correlations based on an analysis of the name change information in the name change database. In addition, a centralized name change database 30 may receive updates from a number of local ANCA systems, where the name change analysis engine 34 relies on a name change questionnaire in which the statistical correlations are continually updated based on the centrally maintained name change database.

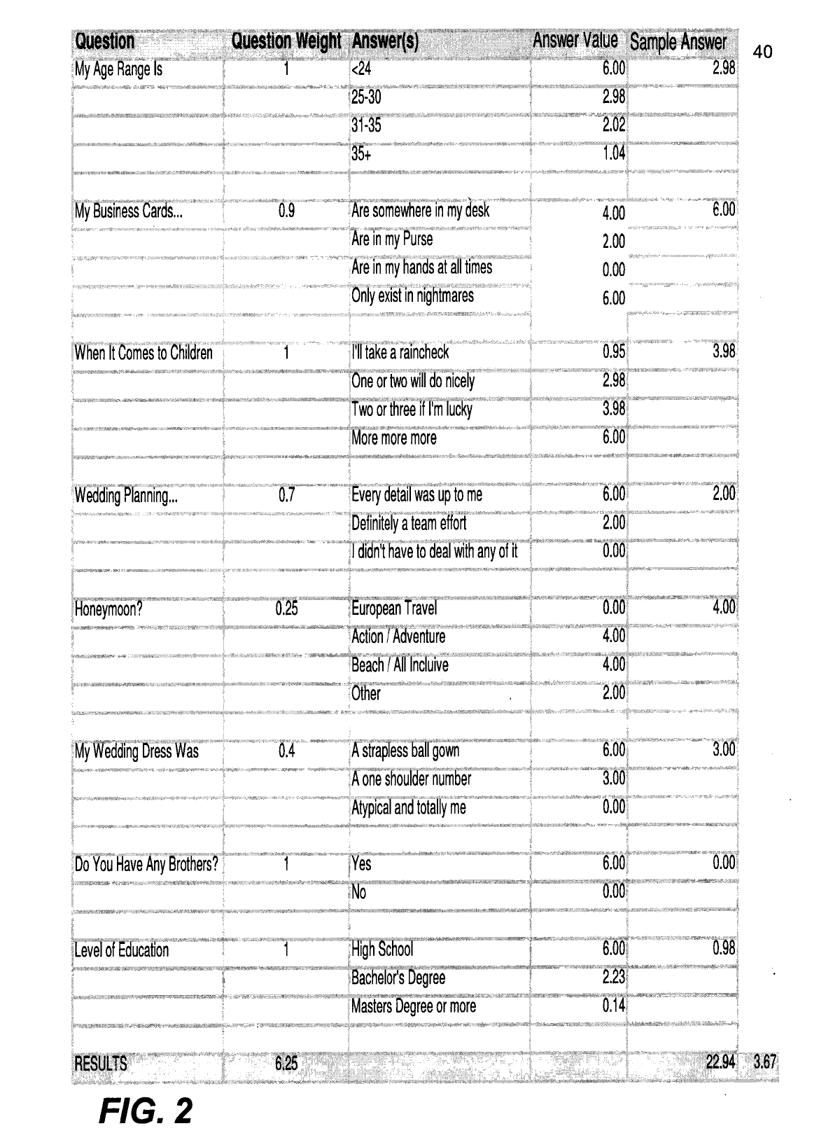

FIG. 2 is an example scoring table 40 for the assisted name change automation system. The table shows the computation of a composite score for one illustrative questionnaire. The scoring table 40 computes a name change score based on the question weights, questionnaire responses, and response weights. The score represents the weighted and normalized sum for all of the questionnaire responses.

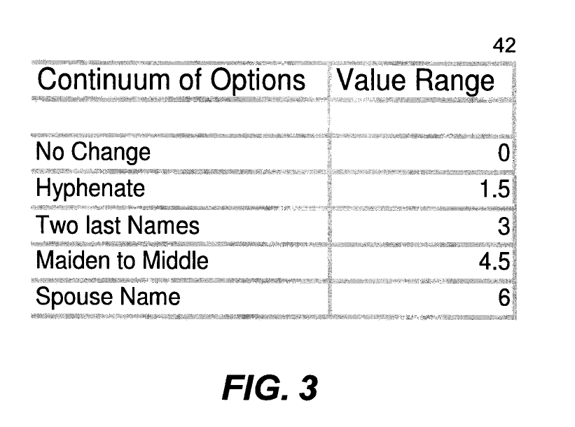

FIG. 3 is an example of a scoring table for the assisted name change automation system. In this example, the various name change recommendations are selected by ranges assigned to the computed name change score. In this particular illustration, no name change is recommended when the name change score falls within the range of zero to 1.5, a hyphenated name is recommended when the name change score falls within the range of 1.5 to 3.0, two last named are recommended when the name change score falls within the range of 3.0 to 4.6, and so forth.

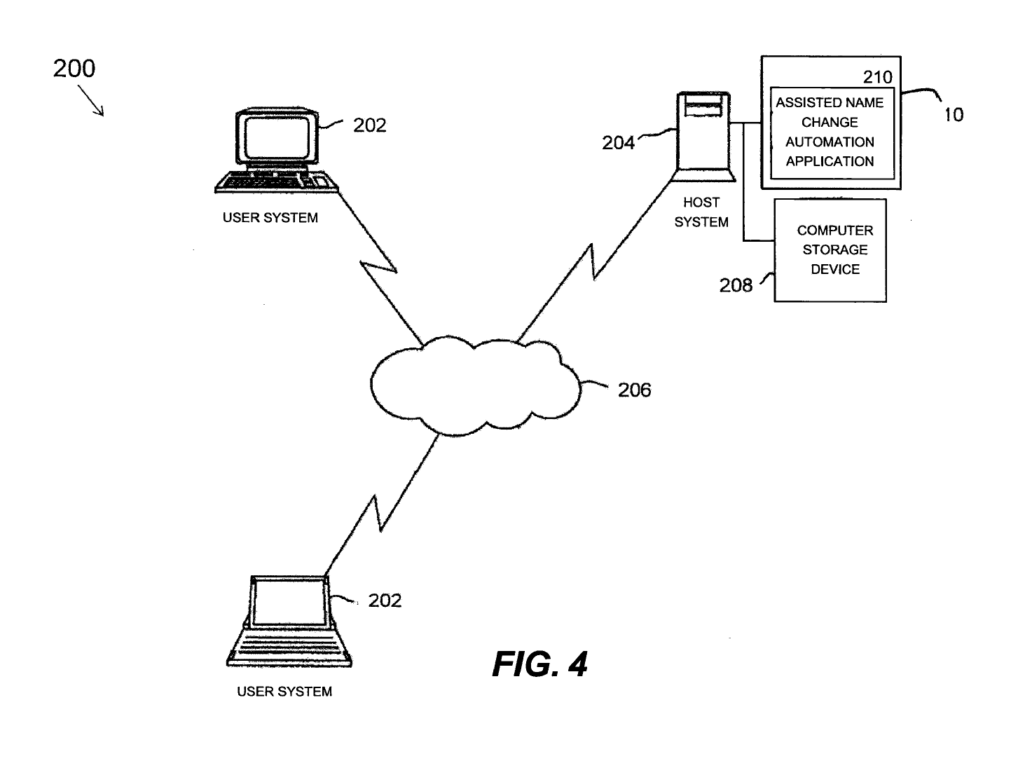

FIG. 4 is an example computer network diagram 200 for the ANCA system. The system 200 includes an ANCA application 210 that is typically executed by on a host computer system 204, which forms the ANCA system 10 when configured with the ANCA application 210. In an embodiment, all or a portion of the ANCA application 210 is part of a database management system executing on the host system 204. In another embodiment, all or a portion of the ANCA application 210 is a component of a system that supports both transactions and queries.

The system 200 includes one or more user systems 202 through which users (e.g., end users, database administrators) at one or more geographic locations may contact the host system 204 to initiate programs that execute database queries and/or transactions. The user systems 202 are coupled to the host system 204 via a network 206. Each user system 202 may be implemented using a general-purpose computer executing a computer program for carrying out the processes described herein. The user systems 202 may be personal computers (e.g., a lap top, a tablet computer, a cellular telephone) or host attached terminals. If the user systems 202 are personal computers, the processing described herein may be shared by a user system 202 and the host system 204. The user systems 202 may also include game consoles, network management devices, and field programmable gate arrays. In addition, multiple user systems 202 and/or host systems 204 may be concurrently operating to perform an assisted name change.

The network 206 may be any type of known network including, but not limited to, a wide area network (WAN), a local area network (LAN), a global network (e.g. Internet), a virtual private network (VPN), a cloud network, and an intranet. The network 206 may be implemented using a wireless network or any kind of physical network implementation known in the art. A user system 202 may be coupled to the host system through multiple networks (e.g., cellular and Internet) so that not all user systems 202 are coupled to the host system 204 through the same network. One or more of the user systems 202 and the host system 204 may be connected to the network 206 in a wireless fashion. In one embodiment, the network is the Internet and one or more user systems 202 execute a user interface application (e.g. a web browser) to contact the host system 204 through the network 206. In another exemplary embodiment, the user system 202 is connected directly (i.e., not through the network 206) to the host system 204. In a further embodiment, the host system 204 is connected directly to or contains the storage device 208.

The storage device 208 includes data relating to computing a join of multiple tables at once and may be implemented using a variety of devices for storing electronic information. In an embodiment, data stored in the storage device 208 includes, but is not limited to, one or more databases, database tables, tree indexes, and other data utilized by embodiments described herein. It is understood that the storage device 208 may be implemented using memory contained in the host system 204 or that it may be a separate physical device. The storage device 208 may be logically addressable as a consolidated data source across a distributed environment that includes the network 206. Information stored in the storage device 208 may be retrieved and manipulated via the host system 204 and/or via a user system 202.

The host system 204 depicted in FIG. 2 may be implemented using one or more servers operating in response to a computer program stored in a storage medium accessible by the server. The host system 204 may operate as a network server (e.g., a web server) to communicate with the user system 202. The host system 204 handles sending and receiving information to and from the user system 202 and can perform associated tasks. The host system 204 may also include a firewall to prevent unauthorized access to the host system 204 and enforce any limitations on authorized access. For instance, an administrator may have access to the entire system and have authority to modify portions of the system. A firewall may be implemented using conventional hardware and/or software as is known in the art.

The host system 204 may also operate as an application server. The host system 204 executes one or more computer programs, including an ANCA application 210, to provide aspects of embodiments as described herein. Processing may be shared by the user system 202 and the host system 204 by providing an application to the user system 202. Alternatively, the user system 202 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

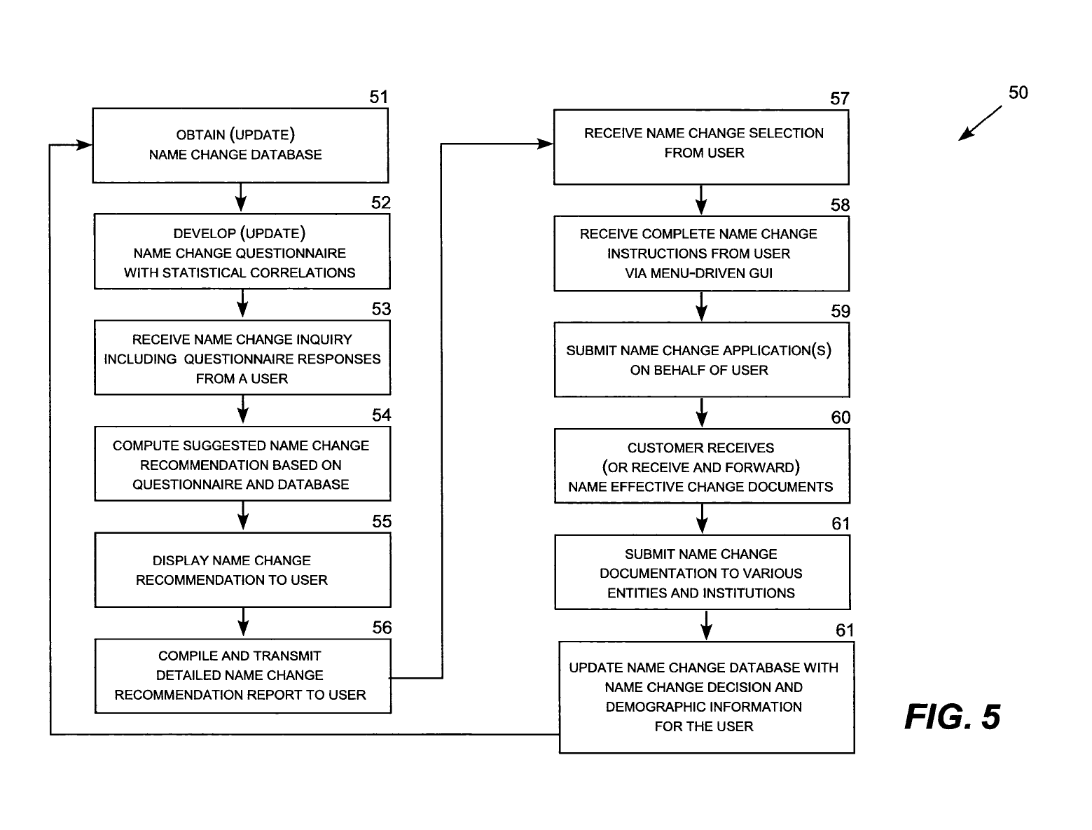

FIG. 5 is a logic flow diagram for an assisted name change procedure 50 providing one example of the methodology that may be implemented by the ANCA system 10. In step 51, the ANCA system obtains or updates or name change database that includes a large body of historical name change decisions and related demographic factors for the persons making the name change decisions. In a particular commercial embodiment, the initial ACNA database includes about 150,000 historical name changed decisions. The database is continually updated through continual use of the ANCA system 10 and may also be updated with additional historical bulk data sources that become available in the future. Step 51 is followed by step 52, in which a marital name change questionnaire is developed with statistical correlations between question responses and the name change decisions derived from the information in the name change database. Certain embodiments of the ANCA system 10 may include the database itself, while other embodiments may only include the questionnaire with statistical correlations based at least in part on the name change information in the name change database. For example, the name change database may be centrally maintained, while local systems only include the questionnaire with statistical correlations, which are periodically updated based on refinement of the centrally maintained database.

Once the questionnaire with statistical correlations is available, it is utilized to compute name change recommendations for an individual user base on the user's questionnaire responses. The beginning of this procedure is represented by step 53, in which the ANCA receives a name change inquiry from a user including the user's responses to the name change questionnaire. Step 53 is followed by step 54, in which the ANCA system computes a name change recommendation based on the user's questionnaire responses and the statistical correlations between questionnaire responses and name change decisions derived from the name change database. Step 54 is followed by step 55, in which the ANCA system displays the computed name change recommendation to the user. As an option, for example where the user has agree to pay a premium, step 55 may be followed by step 56 in which the ANCA system compiles a detailed report concerning the name change recommendation and delivers the report to the user. For example, the name change recommendation report may disclose the underlying demographic data used to compute the name change recommendation, show the percentage breakdowns by questionnaire response, show the questionnaire response scoring, show the scores computed for the other name change options, provide written explanations of considerations, and so forth.

In certain situation in which the user does not proceed with an assisted name change implemented by the ANCA, the methodology may end at step 55 with the delivery of the name change recommendation. In situations where the user elects to proceed with an assisted name change, step 56 is followed by step 57, in which the ANCA receives a name change selection from the user (name change applicant). Step 57 is followed by step 58, in which the ANCA receives complete name change instructions and required documentation from the user through the operation of a detailed menu-driven interface and forms database that assists the user by accessing the correct forms for the user's particular circumstances, prompting the user to enter the information needed to complete the name change application(s), prompting the user to upload required documentation, generating completed forms, and obtaining signatures in a suitable format. Step 58 is followed by step 59, in which the ANCA submits the name change application(s) to the appropriate agencies on behalf of the user. Alternatively, the ANCA may transmit or download the completed forms to the user for the use to sign and submit.

Once the applicable agencies process the name change applications, step 59 is followed by step 60, in which the user receives the name change documents from the agencies. Alternatively, the operator of the ANCA system may receive the documents from the agency and forward them to the name change applicant. In step 62, the user or the ANCA on behalf of the user submits the name change document to the applicable entities and institutions. For example, the name change applicant typically submits certified copies of the name change documents to obtain a new driver's license, a new passport, new credit cards, change the named on insurance policies, title documents, financial accounts, and so forth. Step 61 is followed by step 62, in which the ANCA updates the name change database with the information for this particular name change. As an option, many different local instances of ANCA systems, such as one for each State, may update a centrally maintained name change database. In this case, each local ANCA system may not maintain a local copy of the name change database, instead utilizing a local copy of the most recent version of the questionnaire and statistical correlations, which are periodically updated with the continually updated information in the centrally maintained name change database.

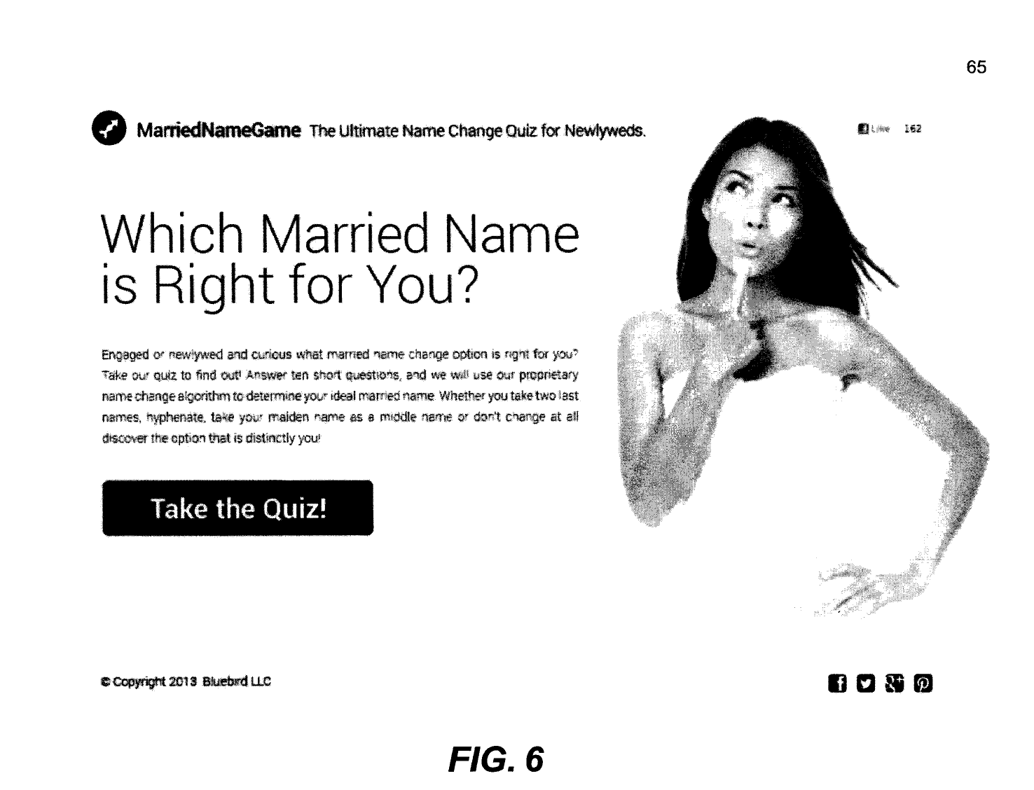

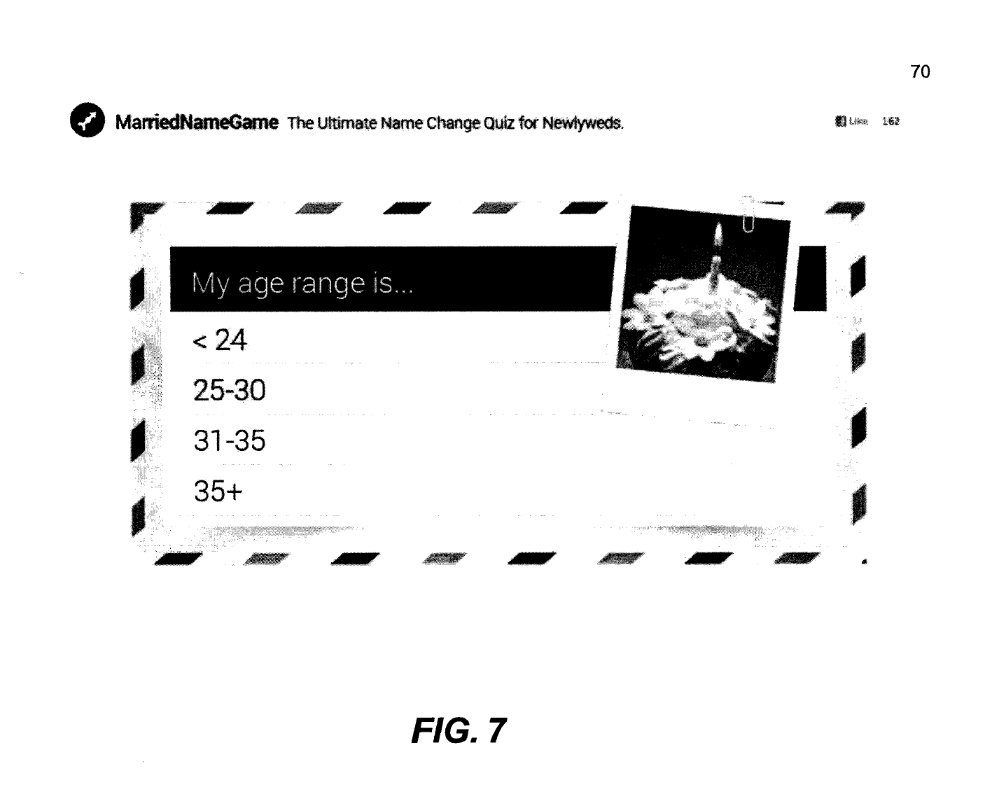

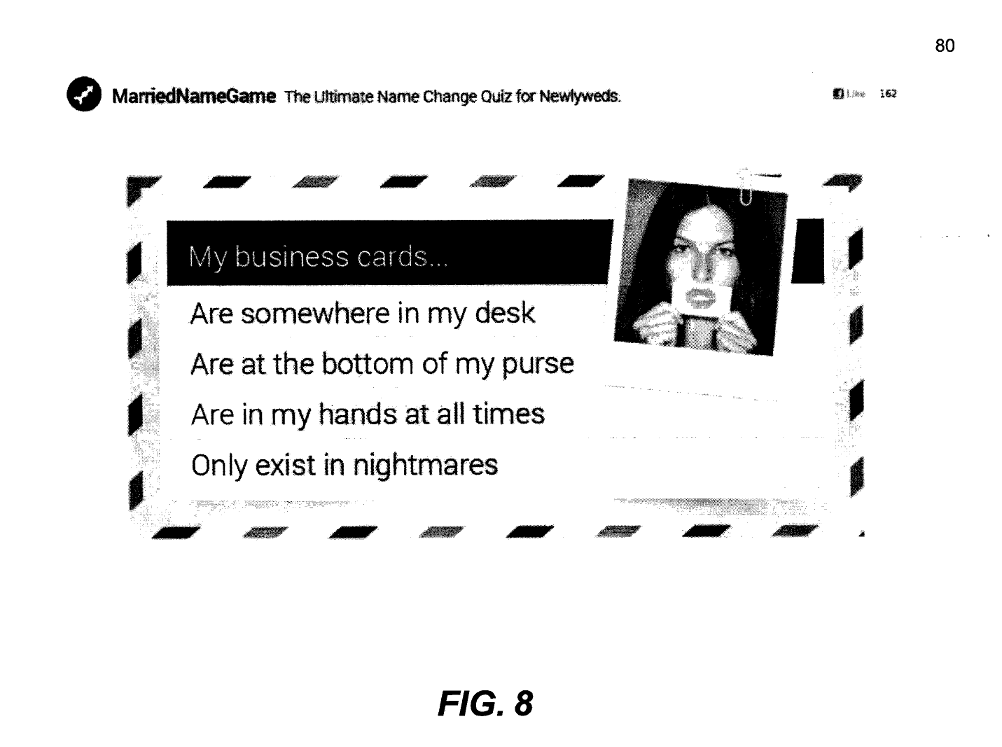

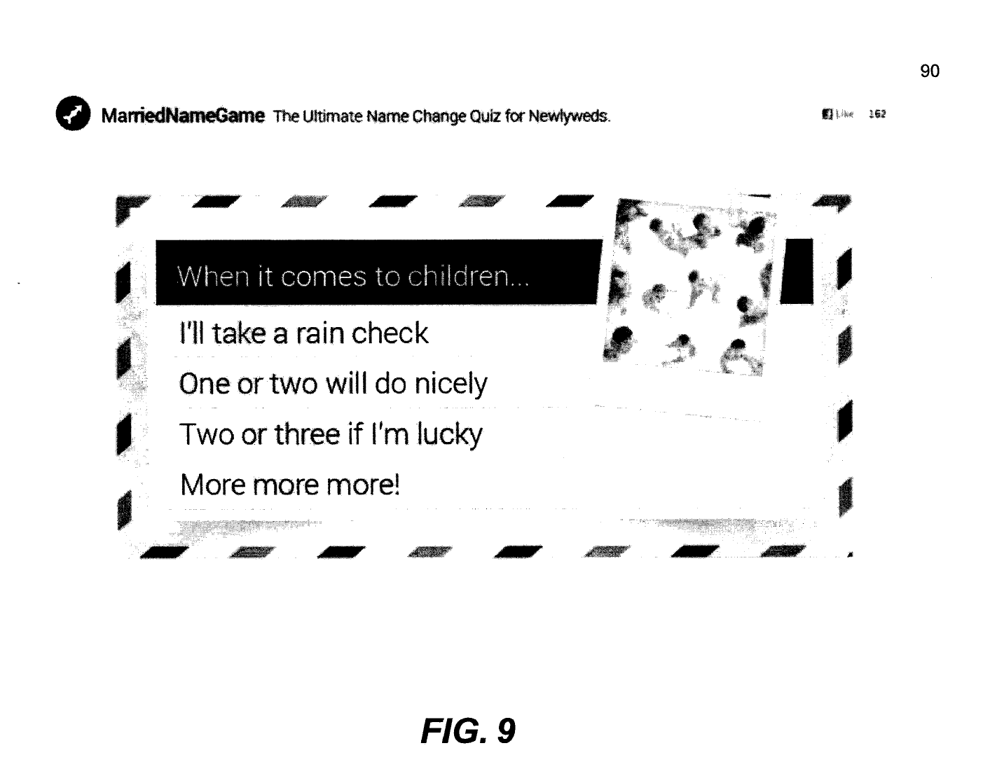

FIGS. 6-17 are screen shots for one particular example of the ANCA system, which are typically completed by a user in the numeric order shown. Any portion of the process may require that the user pay a fee, may display advertising, or implement another suitable financial component. FIG. 6 is a user interface panel 65 for initiating a request for a computer-generated name change recommendation in an assisted name change system, which in this example is presented as an entertaining “quiz” for obtaining a name change recommendation. FIG. 7 is a user interface panel 70 for entering a user's age in the assisted name change system. In general, younger persons are more likely to decide to change their names. FIG. 8 is a user interface panel 80 for entering information regarding the user's use of business cards in the assisted name change system. Heavy use of business cards indicates a user's high professional status, which generally correlates in favor of no change or a change that incorporates her current last name in some manner. FIG. 9 is a user interface panel 90 for entering information regarding the user's preference for having children in the assisted name change system, as many women planning to have children choose to adopt their husband's last name.

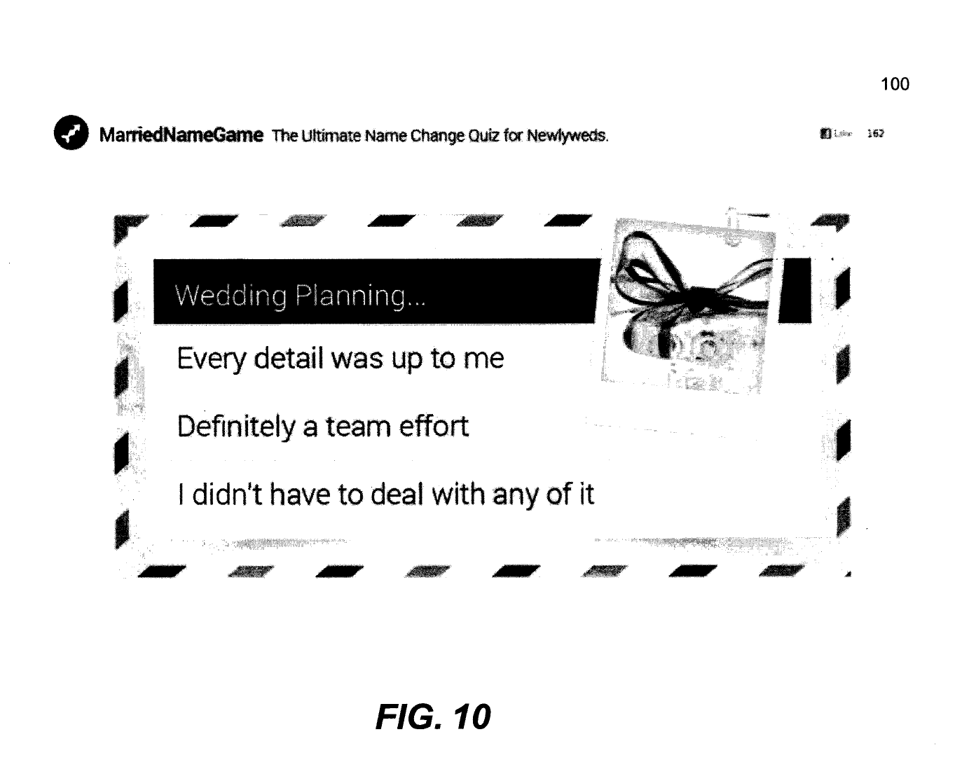

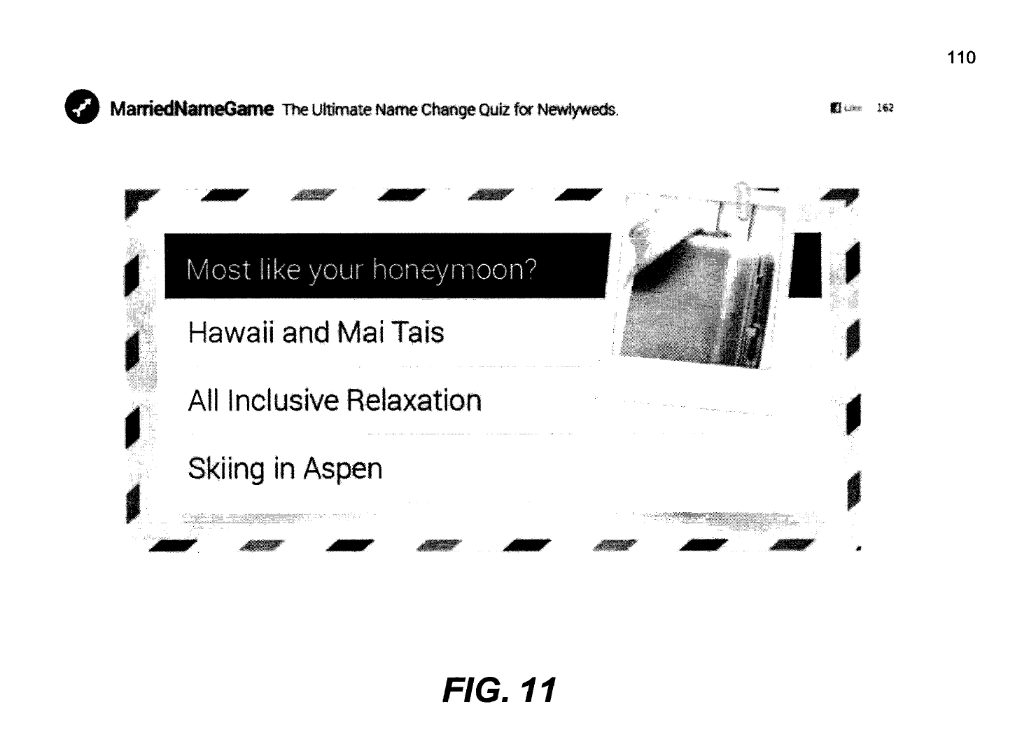

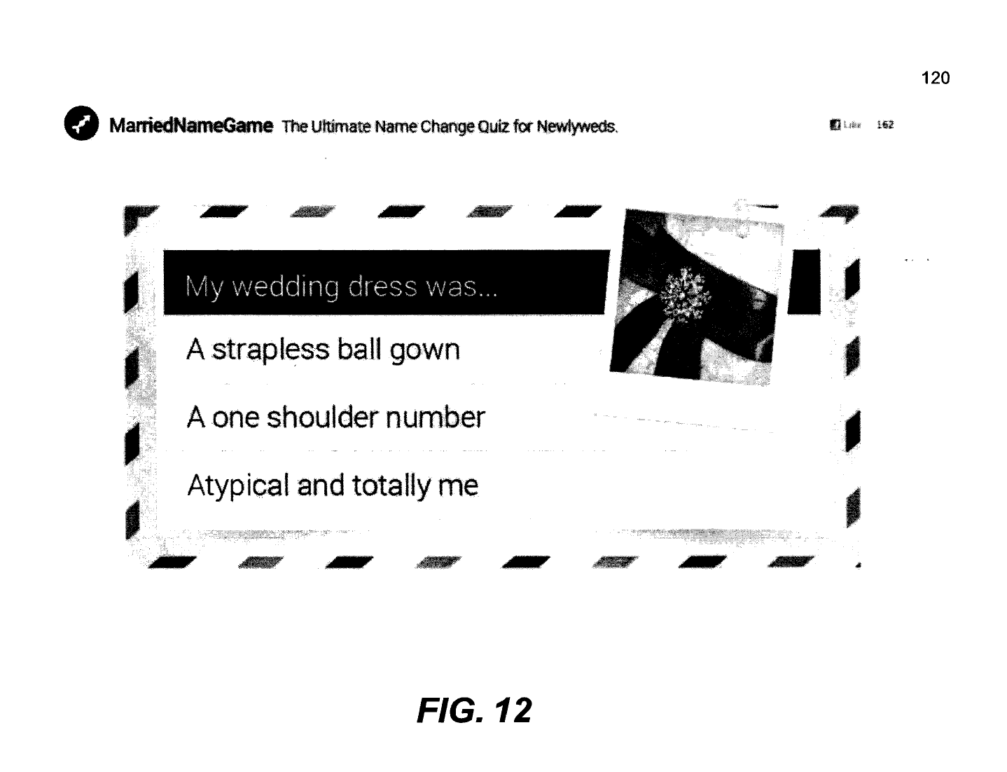

FIG. 10 is a user interface panel 100 for entering information regarding the user's wedding planning in the assisted name change system. This is an indicator of relationship/partnership dynamics, as a person in who took the traditional role of all of the wedding planning or was part of a 50/50 planning role is more likely to adopt her husband's last name in some variation. FIG. 11 is a user interface panel 110 for entering information regarding the user's planned honeymoon in the assisted name change system. Again, a person planning a traditional honeymoon is more likely to adopt her husband's last name in some variation. FIG. 12 is a user interface panel 120 for entering information regarding the user's wedding dress in the assisted name change system, which is a means to assess how traditional a bride is. The more traditional a bride's mindset is, the more likely she is to adopt her spouse's last name in some variation.

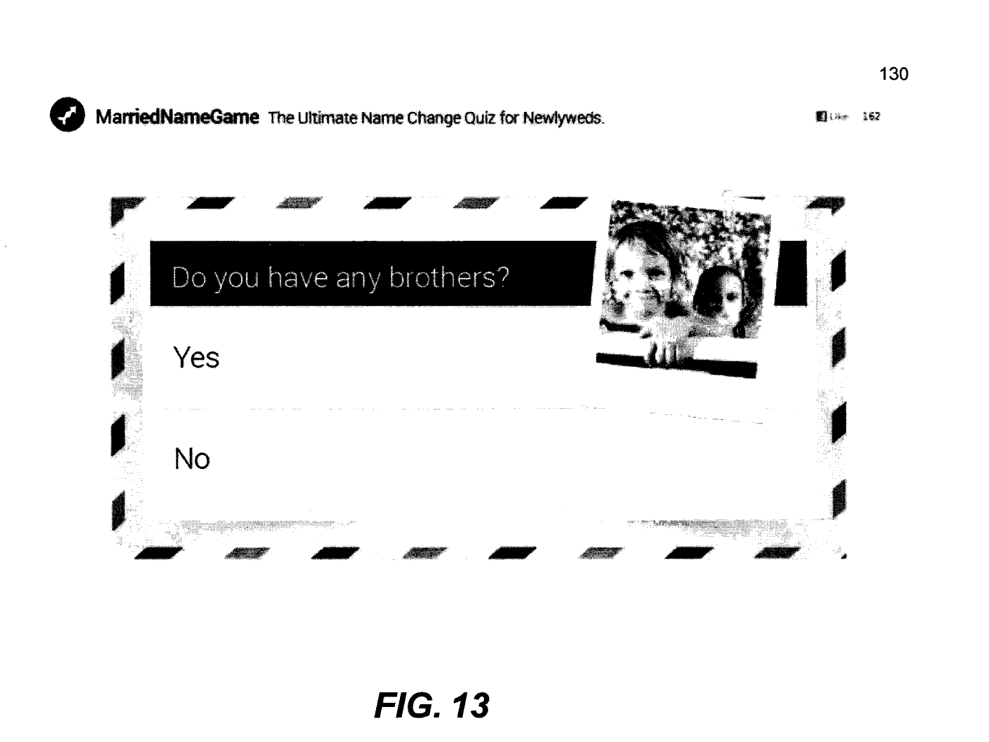

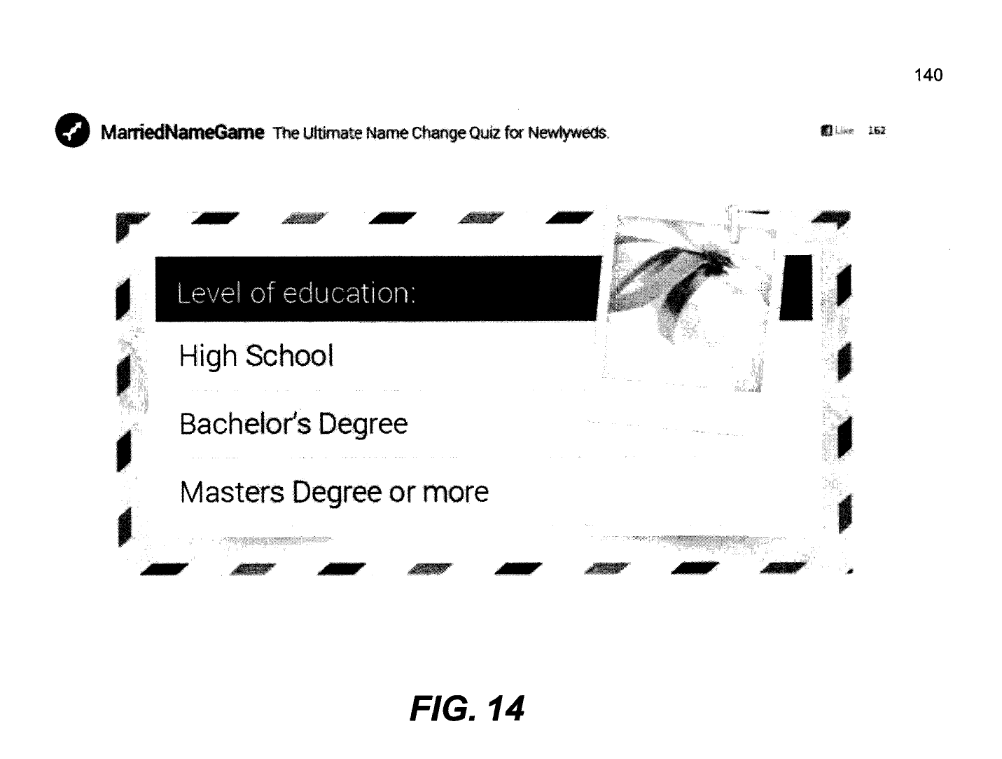

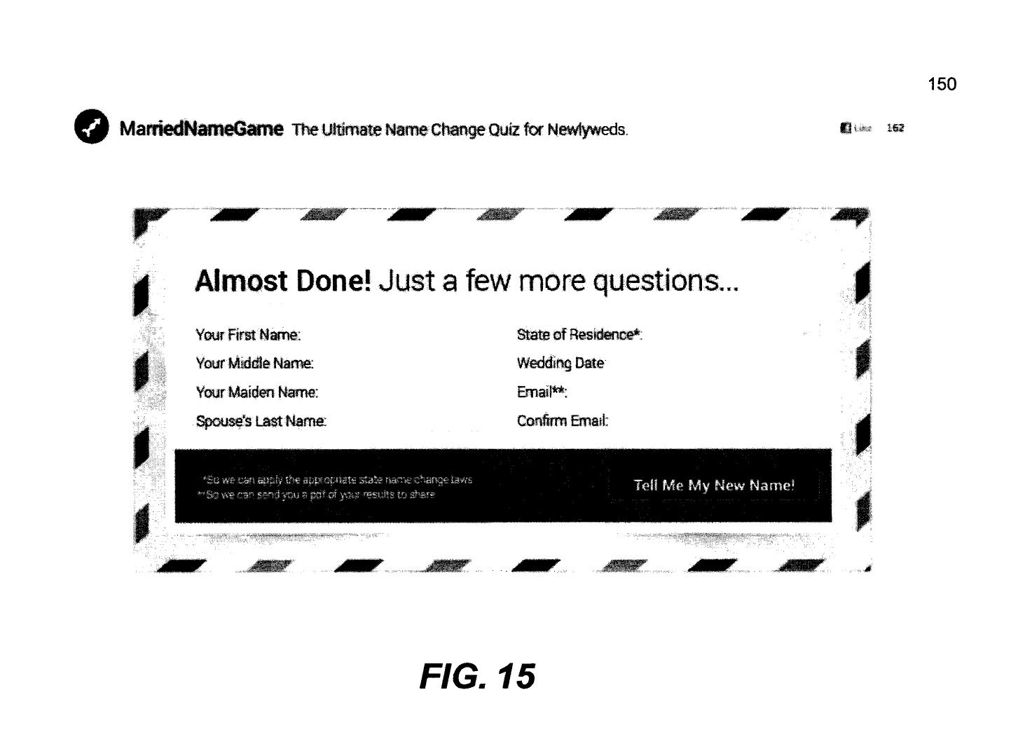

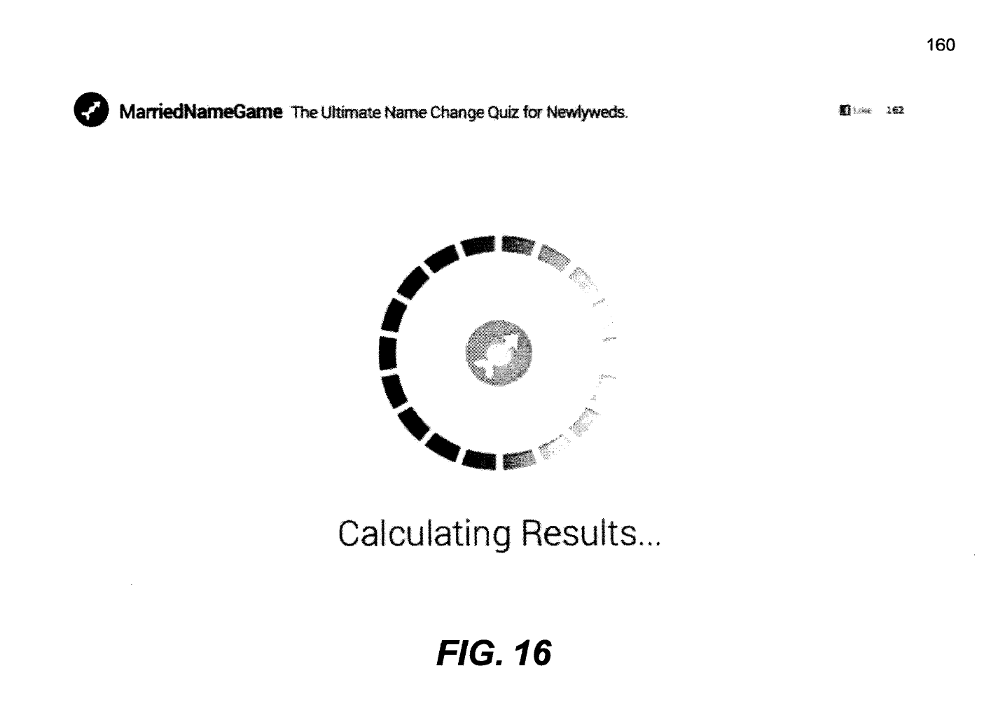

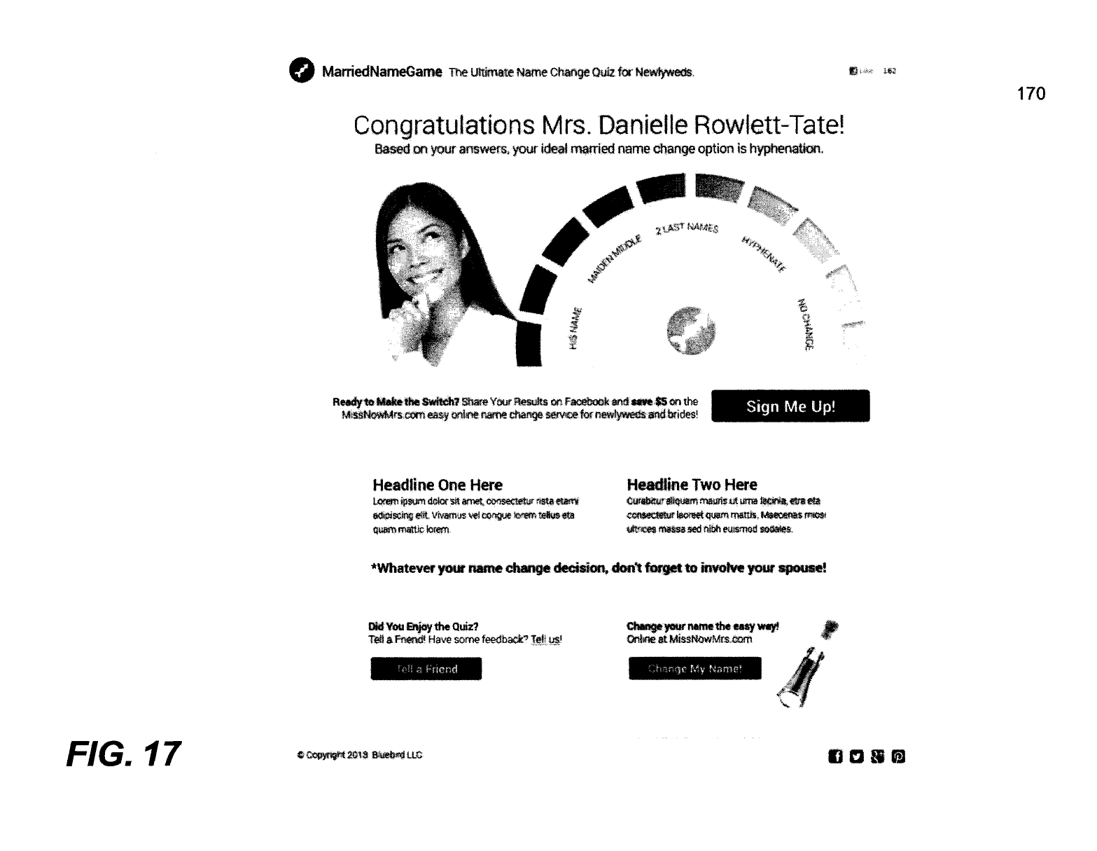

FIG. 13 is a user interface panel 130 for entering information regarding whether the user has brothers in the assisted name change system. A person without at least one brother to carry on the family name is generally more likely to retain her maiden name in some variation. FIG. 14 is a user interface panel 140 for entering information regarding the user's level of education in the assisted name change system. Highly educated and professional persons are more likely to retain their maiden name in some variation. FIG. 15 is a user interface panel 150 for entering information regarding the user's name and address information in the assisted name change system. FIG. 16 is a user interface panel 160 displayed while the assisted name change system computes a name change recommendation for the user. FIG. 17 is a user interface panel 170 displaying the computed name change recommendation to the user.

It will be appreciated that other data items found to be relevant may also be collected. For example, geographic origin, geographic location of family members, age, ethnicity, religious affiliation, education level, profession, employment status, political party affiliation, whether the subject already has children, whether the subject intends to have children in the future, whether the subject has previously changed her name, and other factors that may correlate with name change decisions may be collected and statistically analyzed for correlations within the name change database, or otherwise scored and factored into the name change recommendation. Factors not empirically reflected in the name change database, such as religious affiliation or geographic location of family members, may be analyzed and scored separately. For example, these factors may be assessed through personal interviews, or logical assessment, assigned scores heuristically, and thus factored into the name change recommendation scoring as deemed appropriate or beneficial. Different scoring algorithms may be developed for different situations, such different national origins, religious affiliations, and so forth.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The invention claimed is:

1. A computer-implemented assisted name change recommendation automation (ANCA) system, comprising:
a name change questionnaire comprising a plurality of questions designed to gather information pertinent to a name change decision from a user considering a marital name change;
a plurality of statistical correlations between questionnaire responses and name change decisions based at least in part on a statistical analysis of prior name change decisions by other persons;
a user interface configured to elicit responses from a user to the name change questionnaire;
a name change analysis engine operative for computing a name change recommendation for the user based on the user's responses to the name change questionnaire and the statistical correlations; and
wherein the user interface is further configured to display the name change recommendation to the user.

2. The ANCA system of claim 1, further comprising:
a name change database comprising name change information including a plurality name change decisions and demographic information for a plurality of subjects who have previously made name change decisions; and
wherein the statistical correlations are based at least in part on the name change information in the name change database.

3. The ANCA system of claim 2, further comprising a user interface feature configured to receive a name change selection from the user, further configured to update the name change database based on the name change selection received from the user.

4. The ANCA system of claim 1, wherein the statistical correlations between questionnaire responses and name change decisions include one or more of:
length of the user's maiden and intended spouse's last names; and
the geographic location of the user.

5. The ANCA system of claim 1, wherein the statistical correlations between questionnaire responses and name change decisions include one or more of:
age of the user;
level of education of the user; and
use of business cards by the user.

6. The ANCA system of claim 1, wherein the statistical correlations between questionnaire responses and name change decisions include one or more of:
wedding planning of the user;
honeymoon planning of the user; and
wedding dress selection of the user.

7. The ANCA system of claim 1, wherein the statistical correlations between questionnaire responses and name change decisions include one or more of:
whether the user has brothers;
whether the user intends to have children; and
whether the user has previously made a name change.

8. A method for providing a name change recommendation, comprising the steps of, with a computer:
means for providing a name change questionnaire comprising a plurality of name change questions and statistical correlations between responses to those name change questions and name change decisions based at least in part on a statistical analysis of prior name change decisions;
means for displaying the name change questions to a user considering a marital name change;
means for receiving response to the name change questions from the user;
means for computing a name change recommendation for the user based on the user's responses to the name change questions and the statistical correlations; and
means for displaying the name change recommendation to the user.

9. The method of claim 8, further comprising:
means for compiling a name change database comprising name change information including a plurality name change decisions and demographic information for a plurality of subjects who have previously made name change decisions; and
means for computing the statistical correlations based at least in part on the name change information in the name change database.

10. The method of claim 9, further comprising:
means for receiving a name change selection from the user; and
means for updating the name change database based on the name change selection received from the user.

11. The method of claim 8, further comprising including on the statistical correlations one or more of:
length of the user's maiden and intended spouse's last names; and
the geographic location of the user.

12. The method of claim 8, further comprising including on the statistical correlations one or more of:
age of the user;
level of education of the user; and
use of business cards by the user.

13. The method of claim 8, further comprising including on the statistical correlations one or more of::
wedding planning of the user;
honeymoon planning of the user; and
wedding dress selection of the user.

14. The method of claim 8, further comprising including on the statistical correlations one or more of:
whether the user has brothers;
whether the user intends to have children; and
whether the user has previously made a name change.

15. A computer storage medium comprising non-transitory, computer implementable instructions for causing a computer to perform a method comprising:
providing a name change questionnaire comprising a plurality of name change questions and statistical correlations between responses to those name change questions and name change decisions based at least in part on a statistical analysis of prior name change decisions;
displaying the name change questions to a user considering a marital name change;
receiving response to the name change questions from the user;
computing a name change recommendation(s) for the user based on the user's responses to the name change questions and the statistical correlations; and
displaying the name change recommendation to the user.

16. The computer storage medium of claim 15, further comprising:
compiling a name change database comprising name change information including a plurality name change decisions and demographic information for a plurality of subjects who have previously made name change decisions; and
computing the statistical correlations based at least in part on the name change information in the name change database.

17. The computer storage medium of claim 16, further comprising:
receiving a name change selection from the user; and
updating the name change database based on the name change selection received from the user.

18. The computer storage medium of claim 15, further comprising including on the statistical correlations one or more of:
length of the user's maiden and intended spouse's last names; and
the geographic location of the user.

19. The computer storage medium of claim 15, further comprising including on the statistical correlations one or more of:
age of the user;
level of education of the user; and
use of business cards by the user.

20. The computer storage medium of claim 15, further comprising including on the statistical correlations one or more of:
wedding planning of the user;
honeymoon planning of the user; and
wedding dress selection of the user.
